(19) United States
(12) Patent Application Publication
(10) Pub. No.: US 2006/0007917 A1
(43) Pub. Date: Jan. 12, 2006

(54) Frame transfer method and edge switch

(76) Inventors: Masahiro Saito, Kawasaki (JP); Ryo Maruyama, Kawasaki (JP); Hitoshi Ono, Kawasaki (JP); Kazutaka Kikuta, Kawasaki (JP)

Correspondence Address: KATTEN MUCHIN ROSENMAN LLP, 575 MADISON AVENUE, NEW YORK, NY, 10022-2585, US

(21) Appl. No.: 10/984,483

(22) Filed: Nov. 8, 2004

(30) Foreign Application Priority Data
Jul. 7, 2004 (JP) 2004-200684

(51) Int. Cl. H04L 12/66

(52) U.S. Cl. 370/352

(57) ABSTRACT

A frame transfer method transfers frames in a service provider network that couples to a user network in a broadband network in which a plurality of user networks are coupled via the service provider network. The method receives a user frame that is input from a user network by a first edge switch within the service provider network that is coupled to the user network, and adds header information to the user frame in the first edge switch and outputs the frame that is added with the header information from the first edge switch to a core switch within the service provider network. The header information includes a first address that is unique within the service provider network and is allocated to the first edge switch, a second address that is unique within the service provider network and is allocated to a second edge switch coupled to a user network that becomes a destination, a VLAN value allocated to a network within the service provider network, a first port identifier identifying a port of the first edge switch that receives the user frame, and a second port identifier identifying a port of the second edge switch.

This application claims the benefit of a Japanese Patent Application No. 2004-200684 filed Jul. 7, 2004, in the Japanese Patent Office, the disclosure of which is hereby incorporated by reference.

### BACKGROUND OF THE INVENTION

1. Field of the Invention

The present invention generally relates to frame transfer methods and edge switches, and more particularly to a frame transfer method for transferring frames in a service provider network that connects to a user network in a broadband network in which a plurality of user networks are connected via the service provider network, and to an edge switch for transferring frames using such a frame transfer method.

2. Description of the Related Art

The extended tag virtual local area network (VLAN) is popularly used as a technique for realizing a broadband network. The extended tag VLAN is simple and corresponding switches can be made at a low cost. However, in a broadband network which uses the extended tag VLAN, a core switch must learn an extremely large number of MAC addresses.

Accordingly, when a learning table for the MAC address is exhausted and a rewriting frequently occurs, the performance of the core switch deteriorates. But if the learning table is made large in order to prevent exhaustion, the cost of the core switch becomes high. In addition, the extent to which the learning table is to be enlarged depends on the user network, and there is a problem in that it is difficult to determine a suitable table size.

A system called “Ethernet-over-Ethernet” (Ethernet is a registered trademark) has been proposed to overcome the problem described above, and has been applied to broadband network services. According to the Ethernet-over-Ethernet, with respect to a user frame that is input from the user network side, an edge switch adds a VLAN tag, an MAC address allocated to a port thereof, and an MAC address allocated to a port of a destination edge switch, and sends the user frame with the added VLAN tag and MAC addresses to the core network side. The core switch makes a frame transfer based on the VLAN tag and the MAC address of the edge switch. The destination edge switch eliminates the added VLAN tag, the MAC address allocated to the port of the source edge switch and the MAC address allocated to the port of the destination edge switch to restore the original user frame, and sends the user frame to the user network side.

The MAC address allocated to the port and added at the edge switch is used for the MAC address learning at the core switch. The number of MAC addresses to be learned is at the maximum the number of ports of the edge switches within the network, and the number of MAC addresses to be learned can be suppressed compared to the extended tag VLAN.

A Japanese Laid-Open Patent Application No. 2002-164937 proposes forming a core network of a virtual private network (VPN) by a label switch network, forming an access network with respect to the core network by the VLAN, and providing an apparatus for carrying out an interface function between the label switch network and the VLAN at an edge (or end) of the label switch network.

A Japanese Laid-Open Patent Application No. 2002-247083 proposes a VLAN tunneling ring system which includes an input edge node for adding VLAN encapsulation information to the packet even when an output port operates as an untagged port.

A Japanese Laid-Open Patent Application No. 2002-344476 proposes encapsulating an Ethernet packet (EP) generated in a first network within another EP, and allocating a source address of the encapsulated EP as an address of a port that receives the EP.

According to the conventional systems which use the MAC address allocated to the output port that connects to the user network of the destination edge switch as the destination MAC address, and use the MAC address allocated to the input port that connects to the user network of the source edge switch as the source MAC address, when performing the frame encapsulation, the core switches within the service provider network carry out a transfer process using the MAC address of the port added in the edge switch.

When actually carrying out the transfer process between the core switches, it is sufficient if the destination edge switch can be recognized, and the use of the MAC address of the port is not an effective way of utilizing the learning table from the point of view of efficiently utilizing the limited capacity of the learning table. In addition, when carrying out the transfer process within the edge switch, the destination MAC address within the header of the frame (that is, the MAC address allocated to the port of the edge switch) or the destination MAC address within the user frame is used. However, an upper limit of the number of destinations of the frame becomes the number of ports within the edge switch, and there was a problem in that the process of determining the transfer destination within the edge switch using the MAC address as a retrieval (or search) key is inefficient. This is because the number of combinations that can be represented by the MAC address is considerably large compared to the number of ports within the edge switch.

### SUMMARY OF THE INVENTION

Accordingly, it is a general object of the present invention to provide a novel and useful frame transfer method and edge switch, in which the problems described above are suppressed.

Another and more specific object of the present invention is to provide a frame transfer method and an edge switch, which can reduce the capacity of a learning table within an edge switch and improve the efficiency of a process that determines a transfer destination within the edge switch.

Still another object of the present invention is to provide a frame transfer method for transferring frames in a service provider network that couples to a user network in a broadband network in which a plurality of user networks are coupled via the service provider network, comprising receiving a user frame that is input from a user network by a first edge switch within the service provider network that is coupled to the user network; and adding header information to the user frame in the first edge switch and outputting the frame that is added with the header information from the first edge switch to a core switch within the service provider network, wherein the header information includes a first address that is unique within the service provider network and is allocated to the first edge switch, a second address that is unique within the service provider network and is allocated to a second edge switch coupled to a user network that becomes a destination, a virtual local area network (VLAN) value allocated to a network within the service provider network, a first port identifier identifying a port of the first edge switch that receives the user frame, and a second port identifier identifying a port of the second edge switch. According to the frame transfer method of the present invention, the transfer process in the edge switch can be carried out using the first and second port identifiers within the header information, and the transfer process in the core switch can be carried out using the first and second addresses within the header information. By using the first and second port identifiers, it becomes possible to reduce the capacity of the learning table within the edge switch, to thereby improve the efficiency of the process which determines the transfer destination within the edge switch.

A further object of the present invention is to provide an edge switch for transferring frames in a service provider network that couples to a user network in a broadband network in which a plurality of user networks are coupled via the service provider network, comprising a port configured to receive a user frame that is input from a user network, within the service provider network that is coupled to the user network; and a header information adding part configured to add header information to the user frame and outputting the frame that is added with the header information to a core switch within the service provider network, wherein the header information includes a first address that is unique within the service provider network and is allocated to the edge switch, a second address that is unique within the service provider network and is allocated to another edge switch coupled to a user network that becomes a destination, a virtual local area network (VLAN) value allocated to a network within the service provider network, a first port identifier identifying the port that receives the user frame, and a second port identifier identifying a port of the other edge switch. According to the edge switch of the present invention, the transfer process in the edge switch can be carried out using the first and second port identifiers within the header information, and the transfer process in the core switch can be carried out using the first and second addresses within the header information. By using the first and second port identifiers, it becomes possible to reduce the capacity of the learning table within the edge switch, to thereby improve the efficiency of the process which determines the transfer destination within the edge switch.

Another object of the present invention is to provide an edge switch for transferring frames in a service provider network that couples to a user network in a broadband network in which a plurality of user networks are coupled via the service provider network, comprising a first port configured to receive a frame that is added with header information and is input from the service provider network; a second port configured to receive a frame that is input from a user network that is coupled to the service provider network; and a learning part configured to learn the header information, wherein the header information includes an address that is unique within the service provider network and is allocated to another edge switch within the service provider network that is coupled to the user network, a virtual local area network (VLAN) value allocated to a network within the service provider network, a first port identifier identifying the second port that receives the frame, a sending source address within a user frame in the frame that is input from the service provider network, a VLAN value within a VLAN tag that is allocated within the user network, and a second port identifier identifying the first port of the edge switch that receives the frame from the service provider network. According to the edge switch of the present invention, the transfer process in the edge switch can be carried out using the first and second port identifiers within the header information, and the transfer process in the core switch can be carried out using the first and second addresses within the header information. By using the first and second port identifiers, it becomes possible to reduce the capacity of the learning table within the edge switch, to thereby improve the efficiency of the process which determines the transfer destination within the edge switch.

Still another object of the present invention is to provide an edge switch for transferring frames in a service provider network that couples to a user network in a broadband network in which a plurality of user networks are coupled via the service provider network, comprising at least one port configured to receive a user frame that is input from a user network, within the service provider network that is coupled to the user network; at least one port configured to receive a frame that is added with header information and is input from the service provider network; a header information adding part configured to add header information to the user frame and outputting the frame that is added with the header information to a core switch within the service provider network; and a learning part configured to learn the header information, wherein the header information includes a first address that is unique within the service provider network and is allocated to the edge switch, a second address that is unique within the service provider network and is allocated to another edge switch coupled to a user network that becomes a destination, a virtual local area network (VLAN) value within a VLAN tag that is allocated to a network within the service provider network, a first port identifier identifying the port that receives the user frame from the user network, a second port identifier identifying a port of the other edge switch, a third port identifier identifying the port that receives the frame from the service provider network, and a sending source address within a user frame in the frame that is input from the service provider network. According to the edge switch of the present invention, the transfer process in the edge switch can be carried out using the first and second port identifiers within the header information, and the transfer process in the core switch can be carried out using the first and second addresses within the header information. By using the first and second port identifiers, it becomes possible to reduce the capacity of the learning table within the edge switch, to thereby improve the efficiency of the process which determines the transfer destination within the edge switch.

Other objects and further features of the present invention will be apparent from the following detailed description when read in conjunction with the accompanying drawings.

### BRIEF DESCRIPTION OF THE DRAWINGS

FIG. 1 is a system block diagram showing an embodiment of a frame sending part within an edge switch according to the present invention;

FIGS. 2A through 2D are diagrams showing frame formats at various parts of the frame sending part shown in FIG. 1;

FIG. 3 is a system block diagram showing an embodiment of a frame receiving part within the edge switch according to the present invention;

FIGS. 4A through 4D are diagrams showing frame formats at various parts of the frame receiving part shown in FIG. 3;

FIG. 5 is a system block diagram showing an embodiment of the edge switch according to the present invention that is formed by the frame sending part shown in FIG. 1 and the frame receiving part shown in FIG. 3;

FIG. 6 is a diagram showing an embodiment of a network;

FIGS. 7A through 7D are diagrams showing set values in tables that are stored in edge switches;

FIG. 8 is a diagram for explaining a transfer process of an unlearned unicast frame;

FIGS. 9A through 9D are diagrams showing contents of tables within the edge switches;

FIG. 10 is a diagram for explaining a transfer process of a learned unicast frame;

FIGS. 11A through 11D are diagrams showing contents of tables within the edge switches;

FIG. 12 is a diagram for explaining a transfer process of a multicast frame;

FIGS. 13A through 13D are diagrams showing contents of tables within the edge switches; and

FIG. 14 is a diagram for explaining a transfer process of a unicast frame for a case where learned contents of core switches are erased.

### DESCRIPTION OF THE PREFERRED EMBODIMENTS

The present invention is characterized in that, when encapsulating a frame in a source edge switch that transmits the frame in a service provider network, a modified format is employed such that input port information related to an input port connecting to a user network of the source edge switch and output port information related to an output port connecting to a user network of a destination edge switch are added to a generally employed format.

By employing this modified format, a transfer process within the source and destination edge switches is carried out using a port identifier that is embedded within the frame, and a transfer process between core switches within a service provider network and within the core switches is carried out using an MAC address of the edge switch that is added in the edge switch.

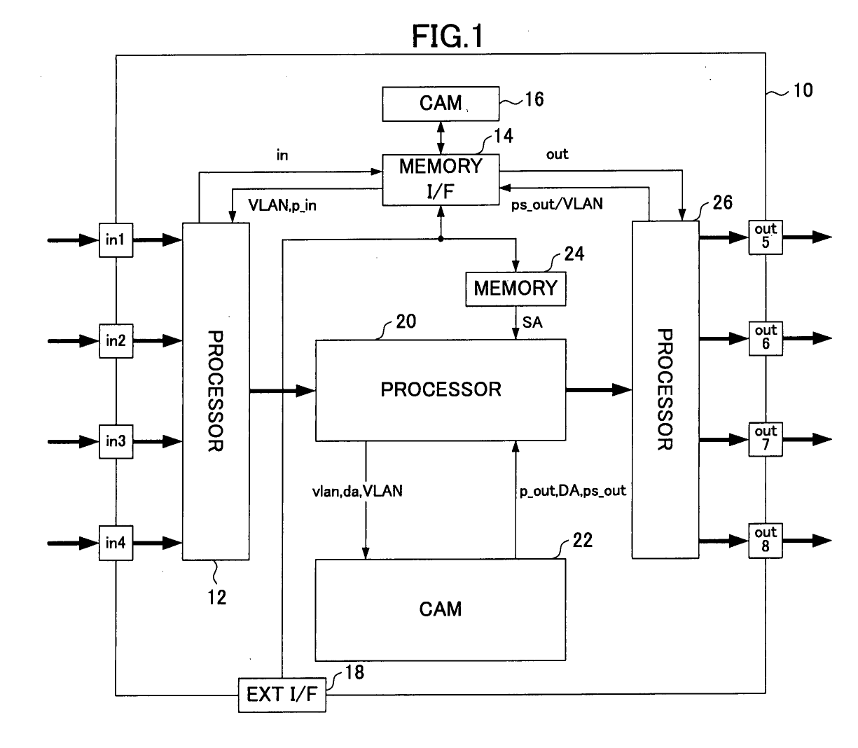

FIG. 1 is a system block diagram showing an embodiment of a frame sending part within an edge switch according to the present invention. A frame sending part 10 shown in FIG. 1 includes input ports in1 through in4 for receiving user frames from user networks, and output ports out5 through out8 for outputting the frames to a core switch side. The number of input ports and the number of output ports are respectively not limited to 4.

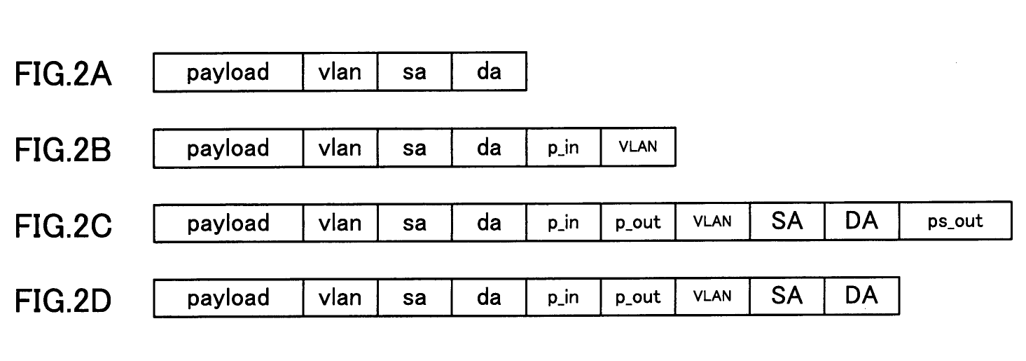

The user frames received by the input ports in1 through in4 are supplied to a processor 12. It is assumed for the sake of convenience that the received user frames have the format of a VLAN frame shown in FIG. 2A. FIGS. 2A through 2D are diagrams showing frame formats at various parts of the frame sending part 10 shown in FIG. 1. The VLAN frame shown in FIG. 2A includes a payload, a VLAN value (vlan) within a VLAN tag that is allocated within the user network, a sending source MAC address (sa), and a destination MAC address (da).

The processor makes access to a content-addressable memory (CAM) 16 via a memory interface 14. The CAM 16 includes as constituent elements thereof a physical port number, a port identifier, and a VLAN value allocated to the network within the service provider network.

The memory interface 14 receives from the processor 12 the physical port number (in) that receives the frame, and makes access to the CAM 16 using the physical port number (in) as the retrieval key, so as to obtain a port identifier (p_in) and the VLAN value (VLAN) allocated to the network within the service provider network, and to send the port identifier (p_in) and the VLAN value (VLAN) to the processor 12. Necessary data are written in advance within the CAM 16 via an external interface 18. The processor 12 transfers to a processor 20 the port identifier (p_in) and the VLAN value (VLAN) allocated to the network within the service provider network, together with the received frame. As shown in FIG. 2B, the data transferred to the processor 20 has the port identifier (p_in) and the VLAN value (VLAN) added to the frame shown in FIG. 2A.

The processor 20 makes access to the CAM 16 using the destination MAC address (da) within the user frame, the VLAN value (vlan) within the VLAN tag that is allocated within the user network, and the VLAN value (VLAN) that is allocated to the network within the service provider network that is added by the processor 12 as retrieval keys, so as to obtain an MAC address (DA) allocated to an edge switch connected to the user network that becomes the destination, a port identifier (p_out) of the edge switch connected to the user network that becomes the destination, and a port identifier (ps_out) on the core switch side of the source edge switch shown in FIG. 1 that outputs the frame. Of course, the MAC address (DA) and the port identifier (ps_out) on the core switch side of the source edge switch may be obtained from another CAM.

In addition, the processor 20 makes access to a memory 24 and obtains an MAC address (SA) that is allocated to the source edge switch. The MAC address of the source edge switch is set in advance in the memory 24 via the external interface 18. The processor 20 assembles a frame which is added with the port identifier (p_out), the MAC address (SA), the MAC address (DA) and the port identifier (ps_out) as shown in FIG. 2C, based on the information read from a CAM 22 and the memory 24, and transfers the assembled frame to a processor 26.

In a case where the user frame is a multicast frame, the processor 20 adds to the frame that is input to the processor 26 a multicast address, as the destination address of the output frame. In addition, the processor 20 specifies the multicasting to the output port within the source edge switch shown in FIG. 1 to which the processor 20 belongs, and regards the multicasting as being specified to the output port of the destination edge switch. The multicast address that is used as the destination address is recognizable in both the core switch and the edge switch. The specifying of the multicasting to the output port is made by a format that is recognizable within the edge switch.

In a case where the user frame is a unicast frame and no corresponding information is stored in the CAM 22, the processor 20 carries out a process similar to that carried out when the multicast frame is received.

The processor 26 makes access to the CAM 16 via the memory interface 14 when the MAC address (DA) allocated to the edge switch connected to the user network that becomes the destination, in the received frame, is not the multicast address.

The memory interface 14 receives from the processor 26 the port identifier (ps_out) on the core switch side of the source edge switch that outputs the frame, and makes access to the CAM 16 using the port identifier (ps_out) as the retrieval key, so as to obtain and send to the processor 26 the physical port number (out). The processor 26 eliminates the port identifier (ps_out) on the core switch side of the source edge switch that outputs the frame, within the received frame, and outputs the frame to the port on the core switch side that is obtained by the retrieval. The frame format in this state becomes as shown in FIG. 2D.

In a case where the DA of the frame received by the processor 26 is the multicast address, the frame is output to all ports accommodating the VLAN value (VLAN) allocated to the network within the service provider network within the frame.

In general, in order to determine the port for outputting the frame, a CAM which stores the VLAN value as the retrieval key and the bit-map of the output ports as the contents, is used. When using this CAM in common as the CAM 16 so as to function as both, the retrieval key becomes the VLAN value (VLAN) allocated to the network within the service provider network, and all port information matching the retrieval key is read to the processor 26 via the memory interface 14. The processor 26 sends with respect to all ports corresponding to the all port information the frame that is obtained by eliminating, the port identifier (ps_out) on the core switch side of the source edge switch that outputs the frame, within the received frame.

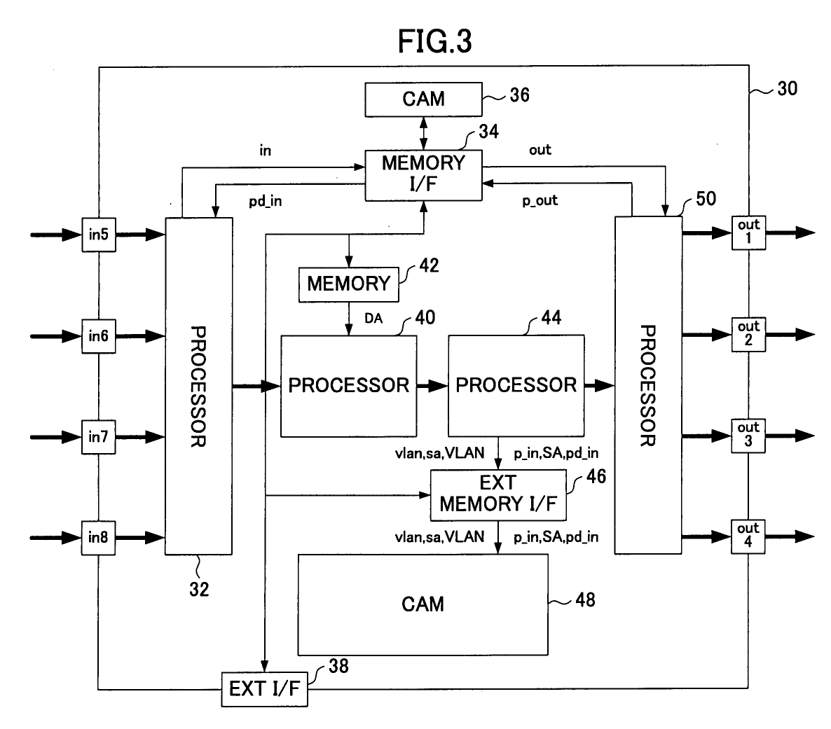

FIG. 3 is a system block diagram showing an embodiment of a frame receiving part within the edge switch according to the present invention. A frame receiving part 30 shown in FIG. 3 includes input ports in5 through in8 for receiving the frames from the core switch within the service provider network, and output ports out1 through out4 for outputting the frames to the user network side. The number of input ports and the number of output ports are respectively not limited to 4.

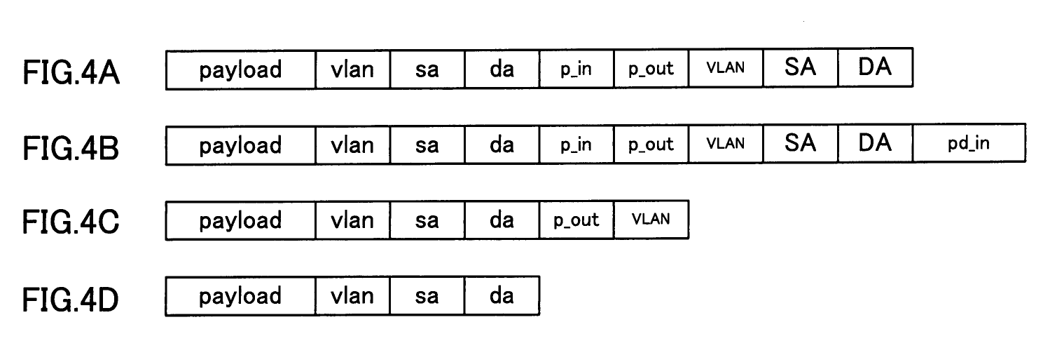

The frames received by the input ports in5 through in8 are supplied to a processor 32. It is assumed for the sake of convenience that the received frames have the format of a VLAN frame shown in FIG. 4A. FIGS. 4A through 4D are diagrams showing frame formats at various parts of the frame receiving part shown in FIG. 3. The processor 32 makes access to a CAM 36 via a memory interface 34. The CAM 36 includes as constituent elements thereof a physical port number, a port identifier, and a VLAN value allocated to the network within the service provider network.

The memory interface 14 receives from the processor 32 the physical port number (in) that receives the frame, and makes access to the CAM 36 using the physical port number (in) as the retrieval key, so as to obtain a port identifier (p_in), and to send the port identifier (p_in) to the processor 32. Data are written in advance within the CAM 36 via an external interface 38. The processor 32 transfers to a processor 40 the port identifier (p_in), together with the received frame. As shown in FIG. 4A, the data transferred to the processor 40 has the port identifier (p_in) added to the received frame.

The processor 40 compares the MAC address of the destination edge switch shown in FIG. 3 stored in a memory 42 and the MAC address (DA) within the received frame, and discards (or annuls) the received frame if the compared MAC addresses do not match. The compared MAC addresses do not match if the frame is flooded in a state where a learning table to be used is in an unlearned state when transferring the frame by the core switch within the service provider network. If the edge switch transfers the frame that is not intended therefor to the user network side, the traffic within the user network is unnecessarily increased thereby, and this is the reason why the received frame is discarded when the compared MAC addresses do not match. On the other hand, when the compared MAC addresses match, the received frame is sent as it is to a processor 44. However, in a case where the MAC address (DA) is a multicast address, the received frame is sent to the processor 44 without comparing the MAC addresses.

The processor 44 writes the sending source MAC address (sa) within the user frame of the received frame, the VLAN value (vlan) within the VLAN tag that is allocated within the user network, the VLAN value (VLAN) allocated to the network within the service provider network, the MAC address (SA) allocated to the source edge switch within the received frame, the port identifier (p_in) of the port connected to the user network by the source edge switch, and port identifier (pd_in) of the port that receives the frame from the core switch side, into a CAM 48, so as to carry out a learning process.

In this embodiment, the CAM 48 shown in FIG. 3 is used in common as the CAM 22 shown in FIG. 1 to function as both. However, the CAM 48 and the CAM 22 may be provided independently, and the data write with respect to the CAM 48 and the CAM 22 may be carried out independently.

The data write (or learning) with respect to the CAM 48 is not limited to the dynamic writing responsive to the received frame. An external memory interface 46 is provided in order to enable setting of the data write (or learning) with respect to the CAM 48 from the external interface 38.

The processor 44 transfers the received frame with respect to a processor 50, simultaneously as carrying out the data write with respect to the CAM 48. In this case, the received frame that is transferred with respect to the processor 50 has a frame format shown in FIG. 4C. Of course, the frame transfer with respect to the processor 50 may be made with a frame format shown in FIG. 4B, and a frame format shown in FIG. 4D may be used within the processor 50. Accordingly, the learning of the frame and the determination of the transfer destination of the frame within the edge switch can be carried out in parallel.

The processor 50 makes access to the CAM 38 via the memory interface 34 in a case where the port identifier (p_out) of the port of the edge switch connected to the user network which becomes the destination, of the received frame, is not a multicast address. The memory interface 34 receives from the processor 50 the port identifier (p_out) of the port of the edge switch connected to the user network which becomes the destination, makes access to the CAM 36 using the port identifier (p_out) as the retrieval key, so as to obtain and send to the processor 50 the physical port number (out).

The processor 50 eliminates from the received frame the port identifier (p_out) of the port of the edge switch connected to the user network which becomes the destination and the VLAN value (VLAN) allocated to the network within the service provider network, and outputs the frame to the port on the service provider network side obtained by the retrieval. The frame output to the port on the service provider network side has a frame format shown in FIG. 4D.

In a case where the port identifier (p_out) of the port of the edge switch connected to the user network which becomes the destination, of the received frame, is a multicast address, the frame is output to all user ports accommodating the VLAN value (VLAN) allocated to the network within the service provider network within the frame.

In general, in order to determine the port for outputting the frame, a CAM which stores the VLAN value as the retrieval key and the bit-map of the output ports as the contents, is used. When using this CAM in common as the CAM 36 so as to function as both, the retrieval key becomes the VLAN value (VLAN) allocated to the network within the service provider network, and all port information matching the retrieval key is read to the processor 50 via the memory interface 34. The processor 50 sends with respect to all ports corresponding to the all port information the frame that is obtained by eliminating, the port identifier (p_out) of the edge switch connected to the user network that becomes the destination, and the VLAN value (VLAN) allocated to the network within the service provider network, within the received frame.

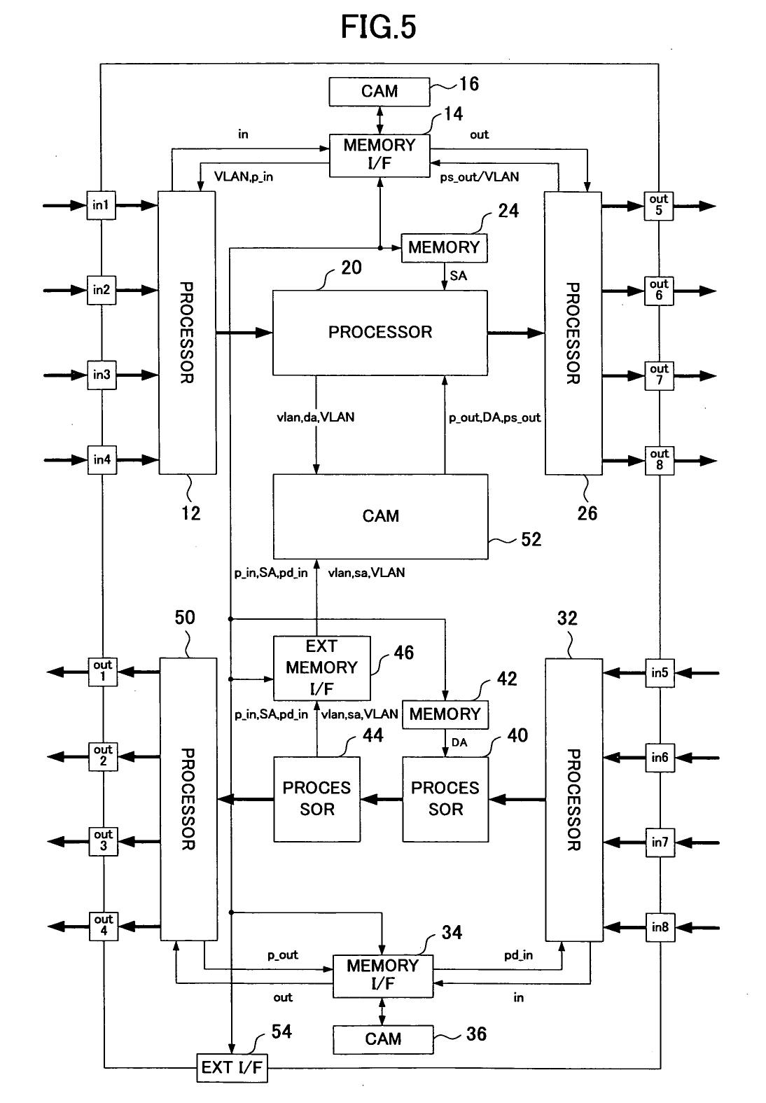

FIG. 5 is a system block diagram showing an embodiment of the edge switch according to the present invention that is formed by the frame sending part shown in FIG. 1 and the frame receiving part shown in FIG. 3. In FIG. 5, those parts which are the same as those corresponding parts in FIGS. 1 and 3 are designated by the same reference numerals, and a description thereof will be omitted. In this embodiment shown in FIG. 5, a common CAM 52 is used to function as both the CAM 22 shown in FIG. 1 and the CAM 48 shown in FIG. 3. In addition, a common external interface 54 is used to function as both the external interface 18 shown in FIG. 1 and the external interface 38 shown in FIG. 3.

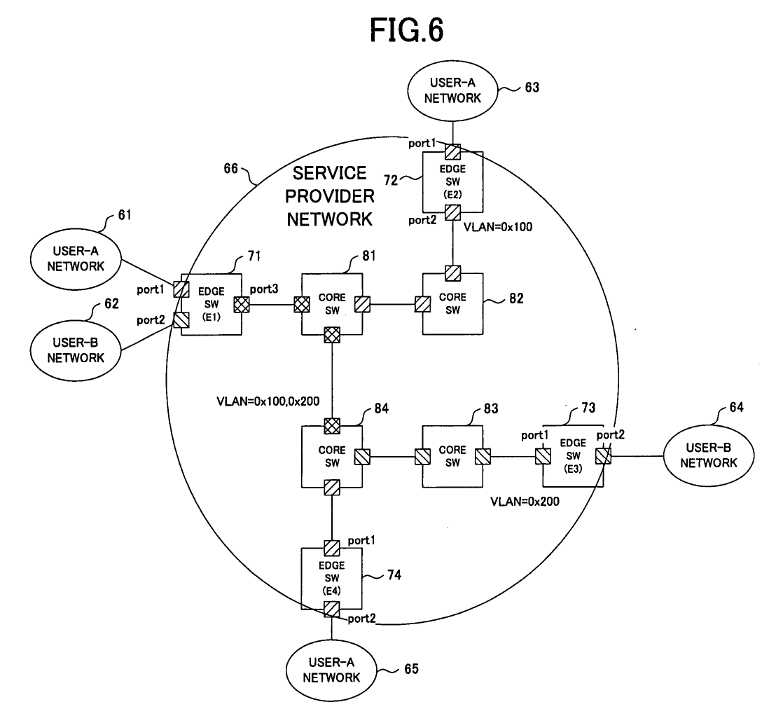

FIG. 6 is a diagram showing an embodiment of a network applied with the present invention. In FIG. 6, a service provider network 66 provides a relay between user-A networks 61, 63 and 64 and user-B networks 62 and 65. An edge switch 71 connects to the networks 61 and 62, an edge switch 72 connects to the network 63, an edge switch 73 connects to the network 64, and an edge switch 74 connects to the network 65. Core switches 81 through 84 are provided in the service provider network 66 and transfer the general VLAN frames.

MAC addresses E1 through E4 are respectively set to the edge switches 71 through 74 of the present invention. With respect to each port of all of the switches within the service provider network 66, a VLAN value 0x100 is set to a port which is indicated by leftwardly descending hatching for relaying the frame of the user-A network, and a VLAN value 0x200 is set to a port which is indicated by a rightwardly descending hatching for relating the frame of the user-B network. VLAN values 0x100, 0x200 are set to a port which is indicated by cross-hatching for relating the frame of the user-A network and the frame of the user-B network. Port identifiers 0x0001 through 0x0003 are respectively set to ports port1 through port3 of the edge switches 71 through 74.

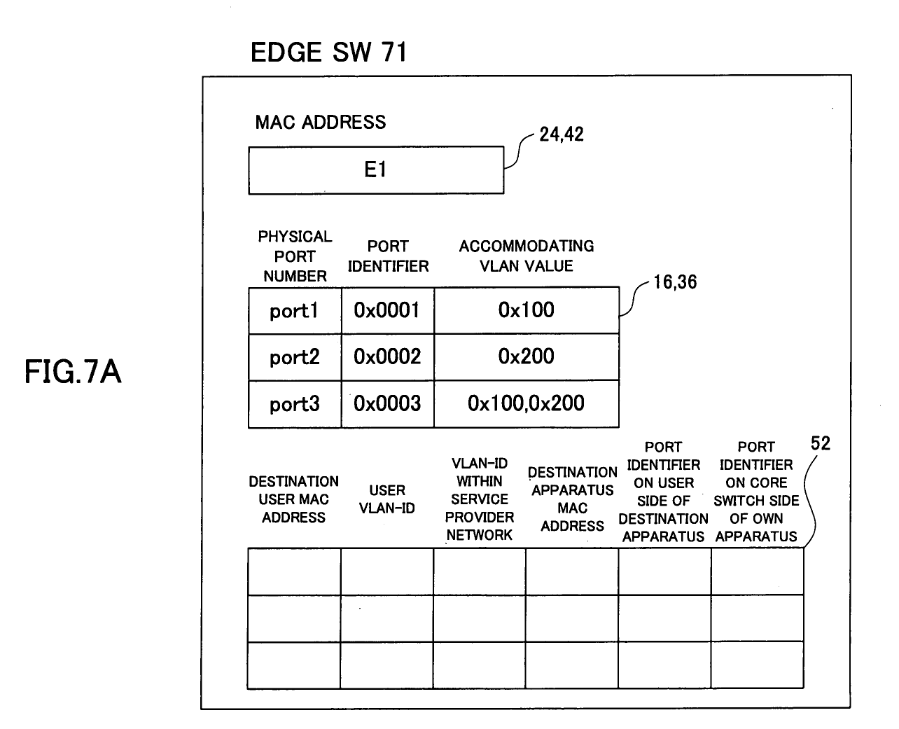

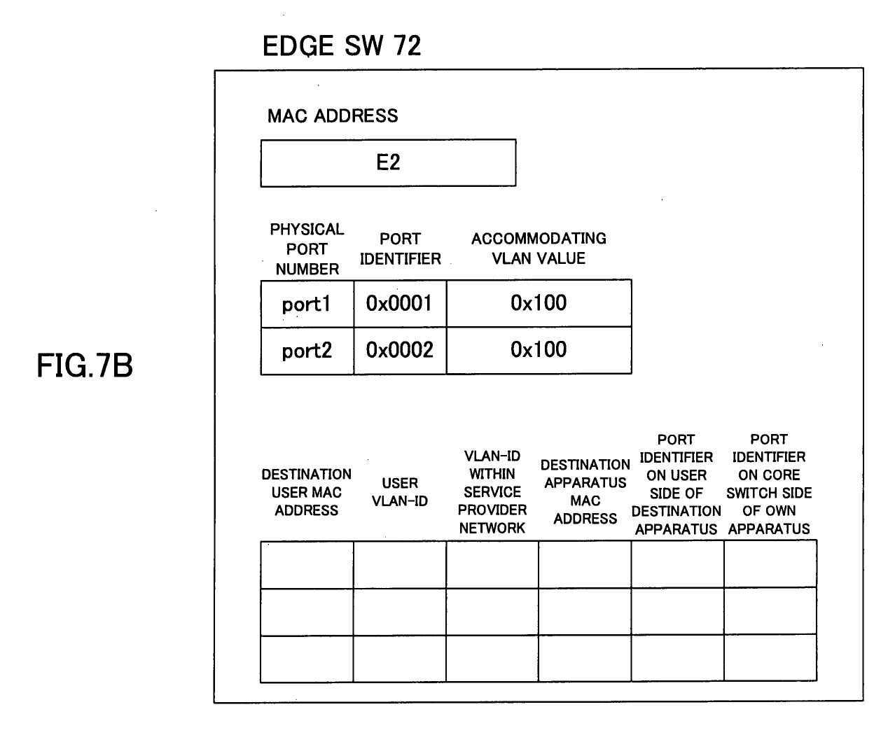

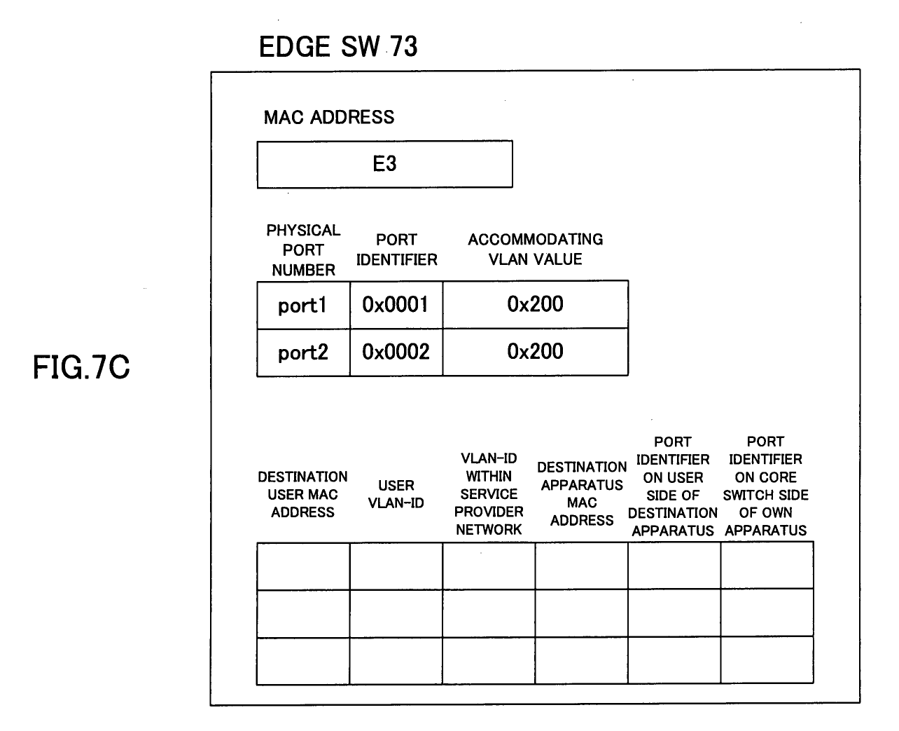

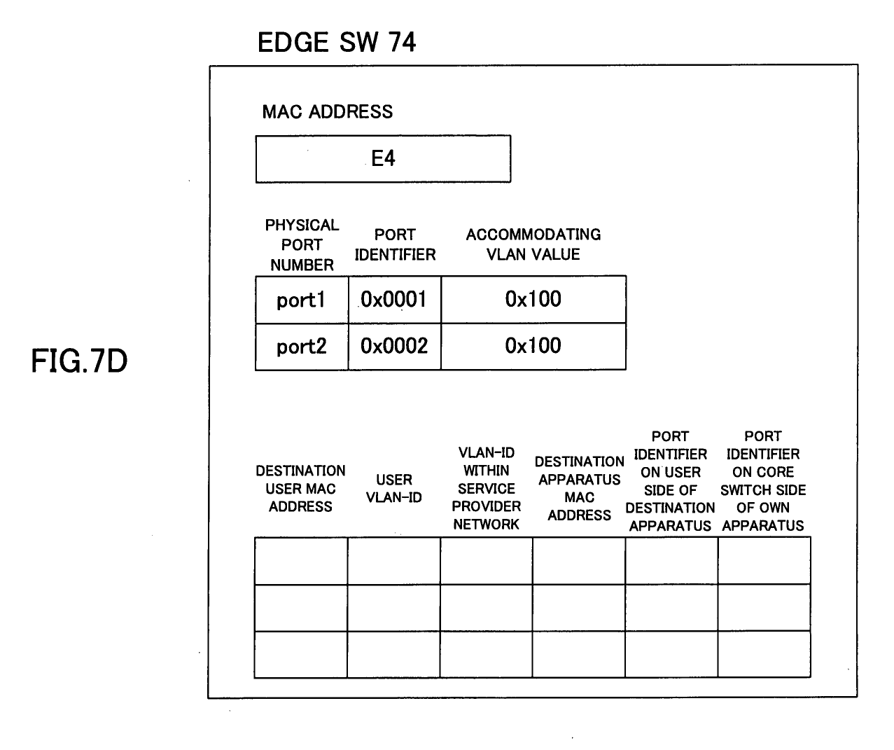

FIGS. 7A through 7D are diagrams showing set values in tables that are stored in the memories 24 and 42 and the CAMs 16, 36 and 52 of each of the edge switches 71 through 74, in an unlearned state. In the case of the edge switch 71, for example, the MAC address E1 of the edge switch 71 is stored in the memories 24 and 42 of the edge switch 71 as shown in FIG. 7A. The port identifier 0x0001 and the accommodating VLAN value 0x100 with respect to the physical port number port1, the port identifier 0x0002 and the accommodating VLAN value 0x200 with respect to the physical port number port2, and the port identifier 0x0003 and the accommodating VLAN values 0x100, 0x200 with respect to the physical port number port3 are stored in the CAMs 16 and 36. No information is set in the CAM 52 since it is still in the unlearned state. Similarly, the values set in the edge switches 72, 73 and 74 are respectively shown in FIGS. 7B, 7C and 7D.

A description will now be given of a transfer process for a case (unlearned unicast frame) where the destination of the frame input from the user-A network is not yet learned within the edge switch.

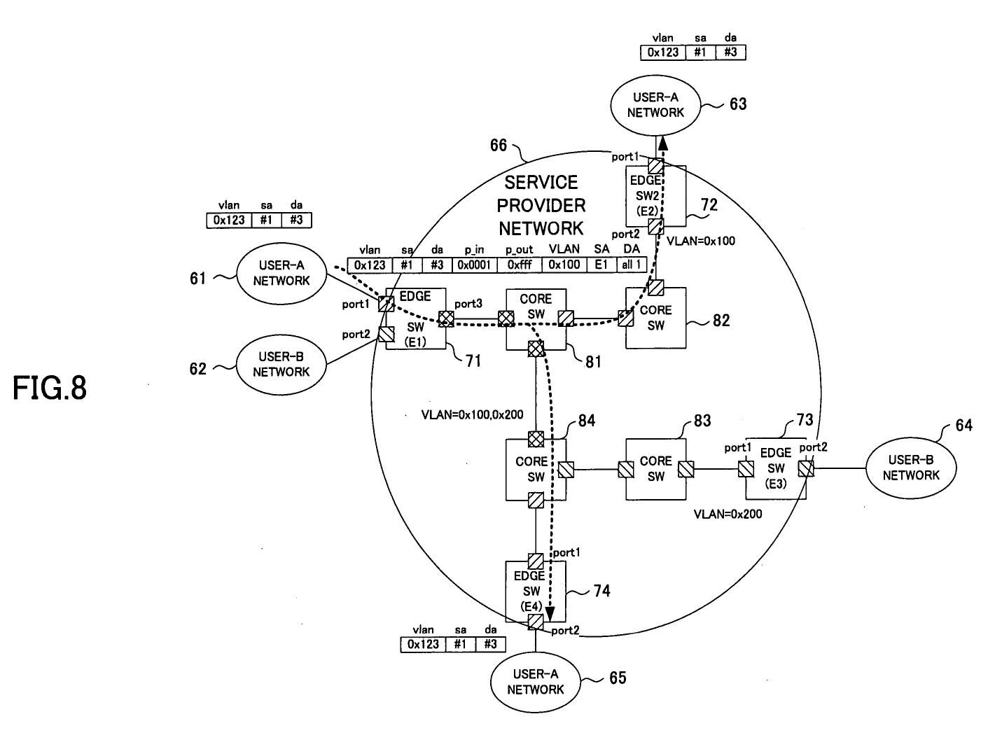

FIG. 8 is a diagram for explaining the transfer process of the unlearned unicast frame. In FIG. 8, those parts which are the same as those corresponding parts in FIG. 6 are designated by the same reference numerals, and a description thereof will be omitted. Suppose that the frame is sent from an apparatus having an MAC address #1 within the user-A network 61 with respect to an apparatus having an MAC address #3 within the user-A network 63, as shown in FIG. 8. It is assumed that the an identifier VLAN-ID=0x123 is allocated to the VLAN within the service provider network 66 which relays the frame from the user-A network 61. The edge switch 71 which receives the frame from the user-A network 61 by the port port1 thereof, makes access to the tables within the CAMs 16 and 36 of the edge switch 71, and reads the port identifier 0x0001 and the accommodating VLAN value 0x100 allocated to the port port1.

Next, a retrieval is made from the tables in the CAM 52 using, as the retrieval key, the identifier VLAN-ID=0x123 and the destination MAC address #3 within the user frame and the accommodating VLAN value 0x100 read from the table described above. Since it is found as a result of the retrieval that no registration exists with respect to the retrieval key, a multicast frame is sent with respect to all ports (excluding the port that receives the frame) accommodating the VLAN value 0x100 of the ports on the core switch side.

The frame that is sent to the core switch 81 is added with the following data with respect to the user frame.

Destination MAC address DA: ff:ff:ff:ff:ff:ff (all “1”: multicast address)

Sending Source MAC address SA: E1

VLAN value (VLAN) within VLAN tag: 0x100

Port identifier p_in of the switch that receives the frame from the user network: 0x0001

Port identifier p_out connected to the user network of the edge switch that becomes the destination: 0xffff

The transfer process within the service provider network 66 is carried out using the destination MAC address (ff:ff:ff:ff:ff:ff) and the VLAN value (0x100), and the frame is transferred in the order of the core switch 81, the core switch 82 and the edge switch 72, and in the order of the core switch 81, the core switch 84 and the edge switch 74.

When the edge switch 72 receives the frame, the edge switch 72 writes the following entries in the tables within the CAM 52.

Sending source MAC address SA: E1

Port identifier p_in of the switch that receives the frame from the user network: 0x0001

Port identifier of the edge switch 72 that receives the frame from the core switch side: 0x0002

VLAN value (VLAN) within the service provider network 66: 0x100

VLAN value (vlan) within the user frame: 0x123

Sending Source MAC address (sa) within the user frame: #1

Similarly, when the edge switch 74 receives the frame, the edge switch 74 writes the following entries in the tables within the CAM 52.

Sending source MAC address SA: E1

Port identifier p_in of the switch that receives the frame from the user network: 0x0001

Port identifier of the edge switch 74 that receives the frame from the core switch side: 0x0001

VLAN value (VLAN) within the service provider network 66: 0x100

VLAN value (vlan) within the user frame: 0x123

Sending Source MAC address (sa) within the user frame: #1

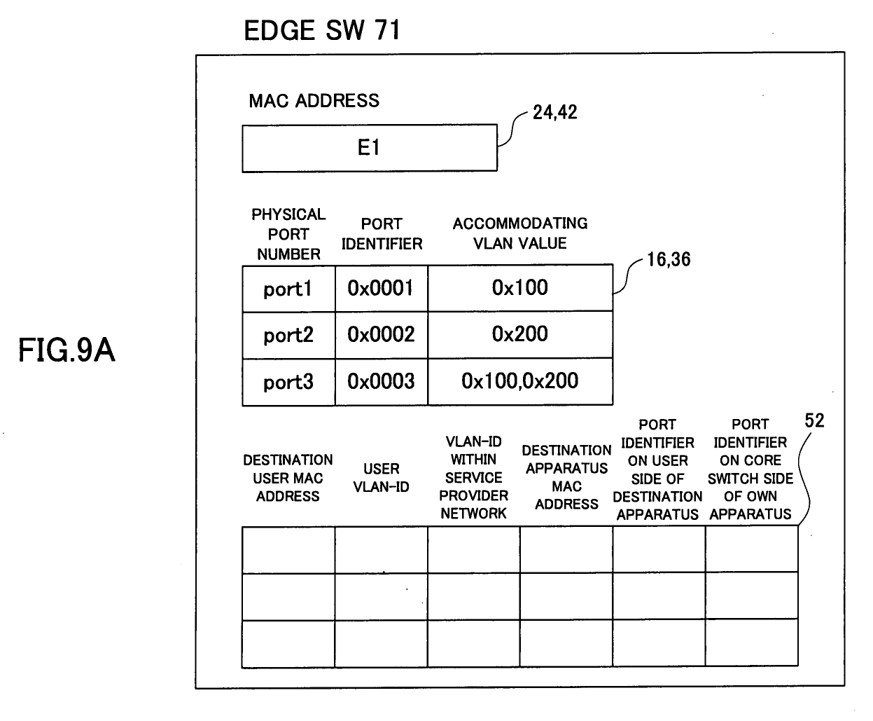

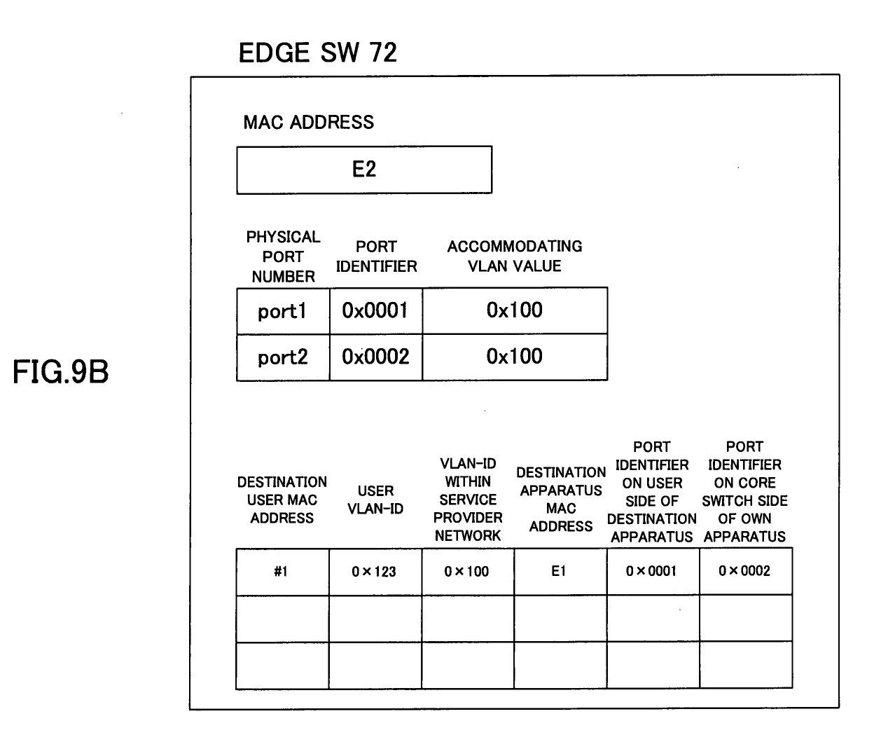

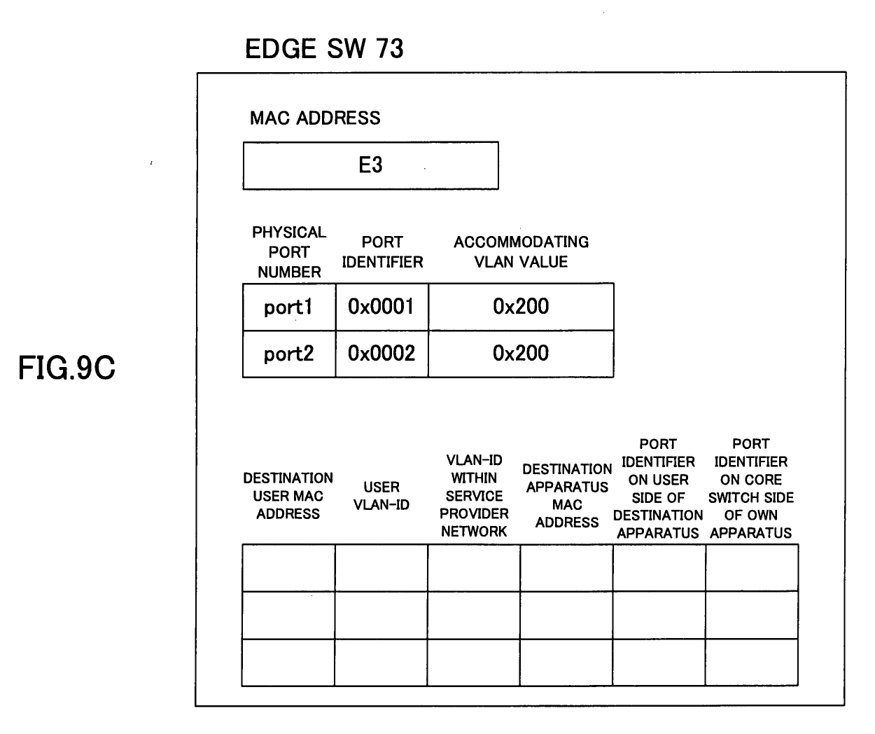

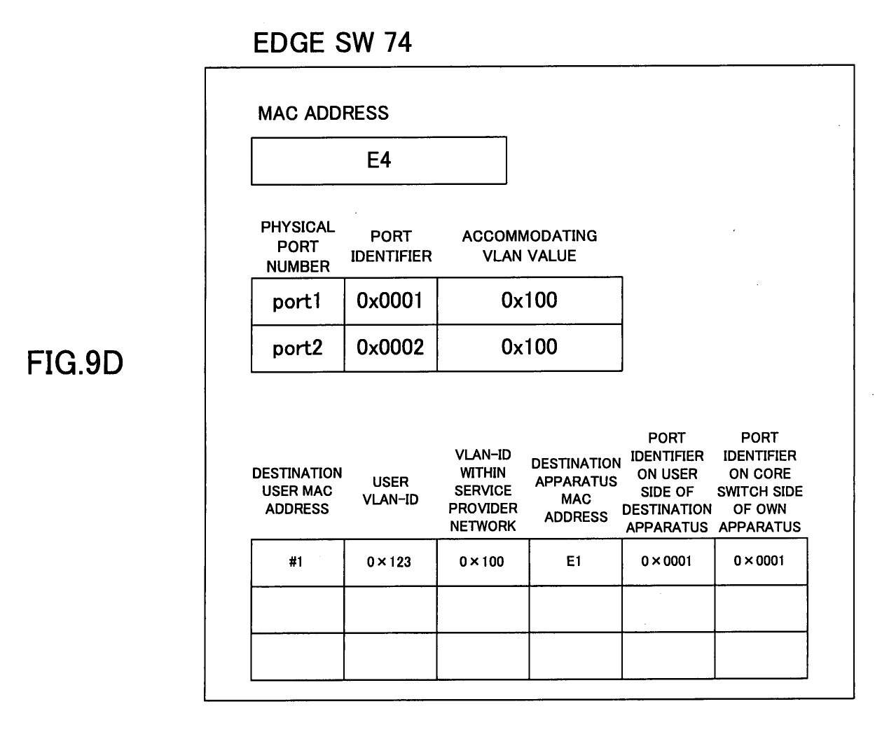

Since the frame received by the edge switches 72 and 74 is the multicast frame, the edge switches 72 and 74 eliminate the information added in the sending source edge switch 71 from the frame and send the frame with respect to all ports on the user network side of the user-A network accommodating the VLAN value 0x100 within the service provider network 66. FIGS. 9A through 9D are diagrams showing contents of the tables within each of the edge switches 71 through 74 after relaying the frame. In FIGS. 9A through 9D, the VLAN value is indicated as VLAN-ID.

Next, a description will be given of a transfer process for a case (learned unicast frame) where the destination of the frame input from the user-A network has been learned within the edge switch.

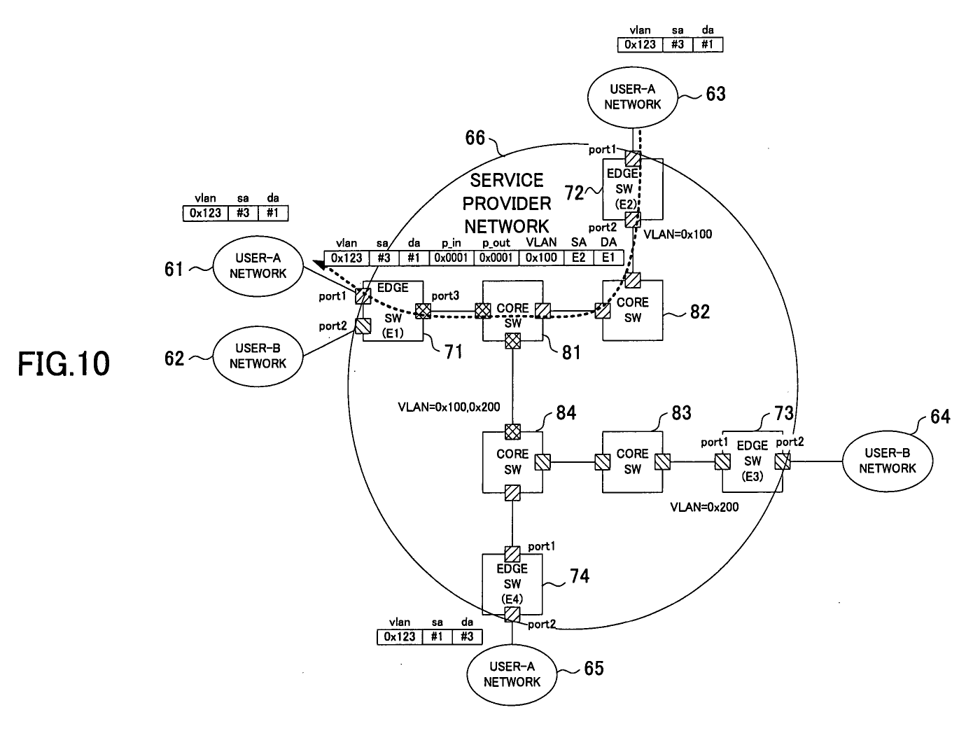

FIG. 10 is a diagram for explaining the transfer process of the learned unicast frame. In FIG. 10, those parts which are the same as those corresponding parts in FIG. 8 are designated by the same reference numerals, and a description thereof will be omitted. It is assumed that, in a state where the tables within the edge switches 71 through 74 are in the states shown in FIGS. 9A through 9D, the frame is sent from an apparatus having an MAC address #3 within the user-A network 63 with respect to an apparatus having an MAC address #1 within the user-A network 61, as shown in FIG. 10.

The edge switch 72 which receives the frame from the user-A network 63 by the port port1 thereof, makes access to the tables within the CAMs 16 and 36 of the edge switch 72, and reads the port identifier 0x0001 and the accommodating VLAN value 0x100 allocated to the port port1.

Next, a retrieval is made from the tables in the CAM 52 using, as the retrieval key, the VLAN value (vlan)=0x123 and the destination MAC address #1 within the user frame and the accommodating VLAN value 0x100 read from the table described above. Since it is found as a result of the retrieval that a registration exists with respect to the retrieval key, the frame is output to the port port2 on the core switch side based on the port identifier 0x0002 of the edge switch 72 stored within the table of the CAM 52.

The frame that is sent to the core switch 81 is added with the following data with respect to the user frame.

Destination MAC address DA: E1

Sending Source MAC address SA: E2

VLAN value (VLAN) within VLAN tag: 0x100

Port identifier p_in of the switch that receives the frame from the user network: 0x0001

Port identifier p_out connected to the user network of the edge switch that becomes the destination: 0x0001

The transfer process within the service provider network 66 is carried out using the destination MAC address (E1) and the VLAN value (0x100), and the frame is transferred in the order of the core switch 82, the core switch 81 and the edge switch 71.

When the edge switch 71 receives the frame, the edge switch 71 writes the following entries in the tables within the CAM 52.

Sending source MAC address SA: E2

Port identifier p_in of the switch that receives the frame from the user network: 0x0001

Port identifier of the edge switch 71 that receives the frame from the core switch side: 0x0003

VLAN value (VLAN) within the service provider network 66: 0x100

VLAN value (vlan) within the user frame: 0x123

Sending Source MAC address (sa) within the user frame: #3

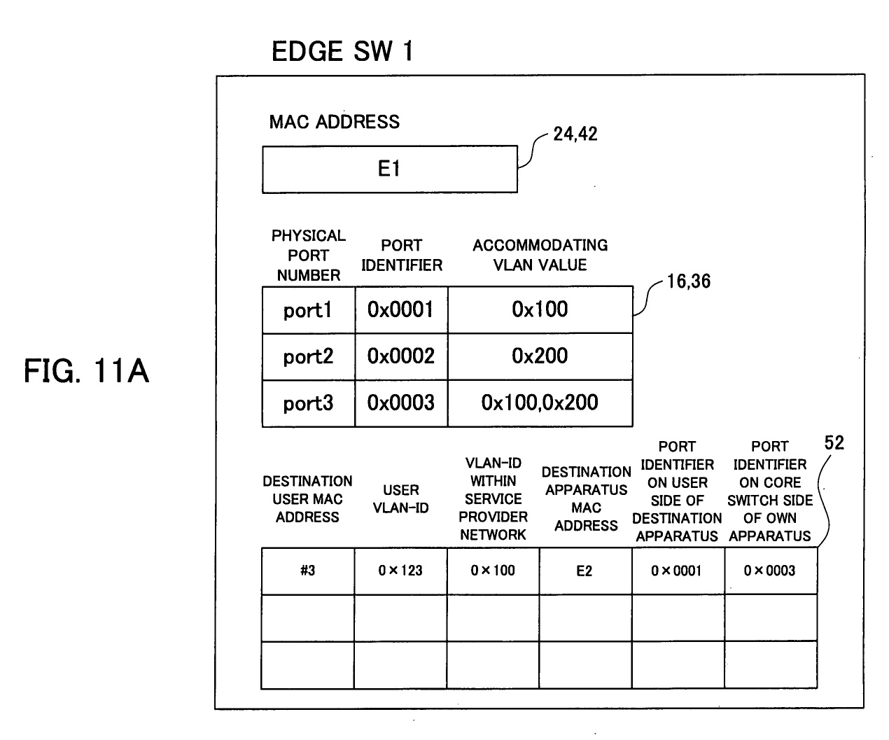

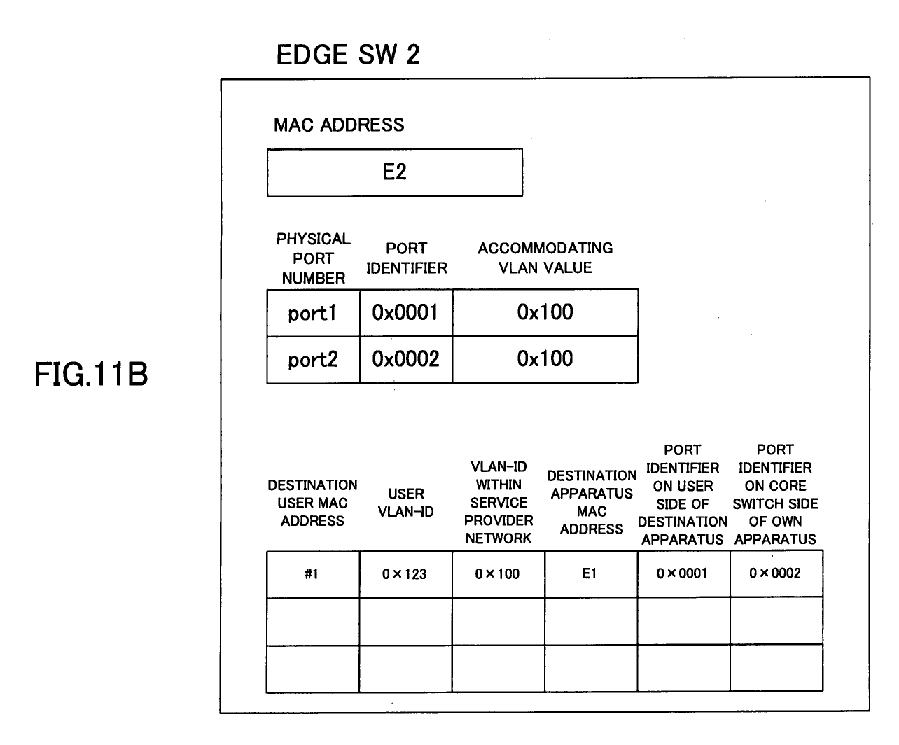

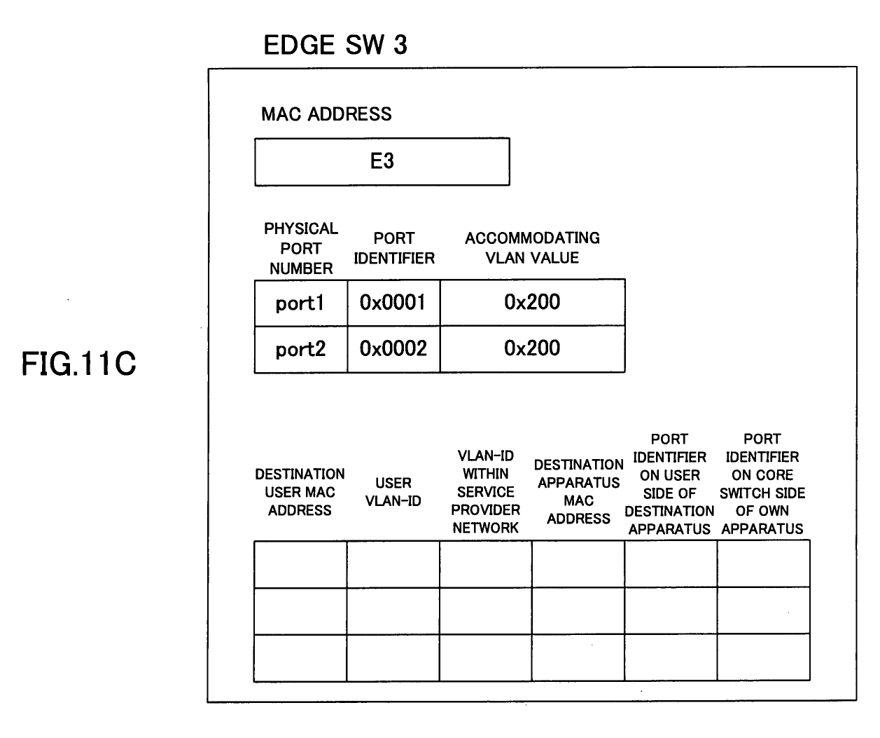

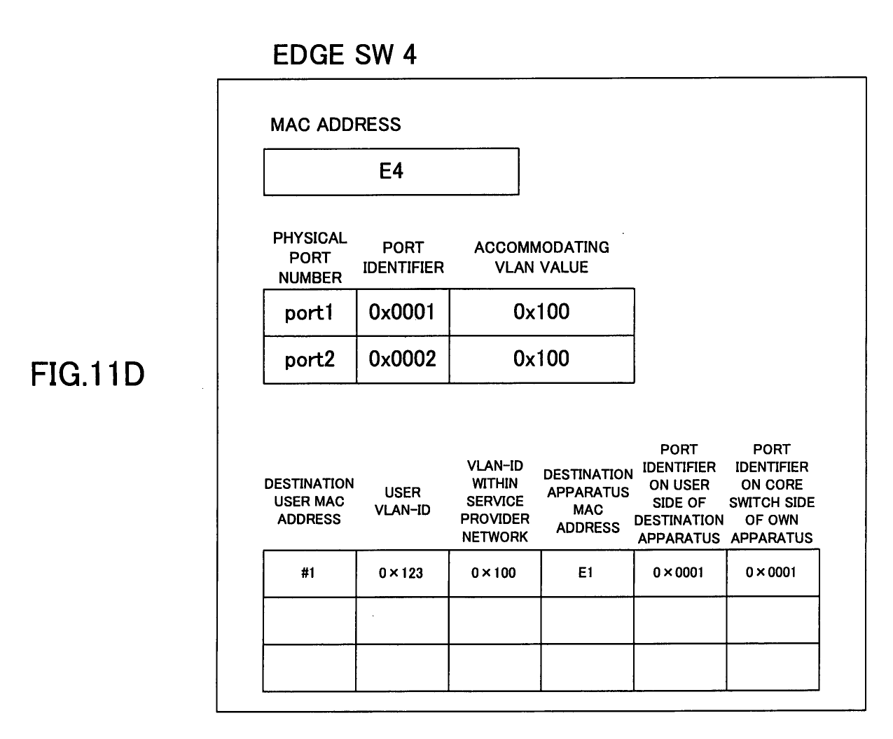

Since the frame received by the edge switch 71 is the unicast frame intended for the edge switch 71, the edge switch 71 eliminates the information added in the sending source edge switch 72 from the frame and sends the frame with respect to the port port1 by judging this port port1 from the destination port identifier 0x0001. FIGS. 11A through 11D are diagrams showing contents of the tables within each of the edge switches 71 through 74 after relaying the frame. In FIGS. 11A through 11D, the VLAN value is indicated as VLAN-ID.

Next, a description will be given of a transfer process for a case where the frame input from the user-B network is a multicast frame.

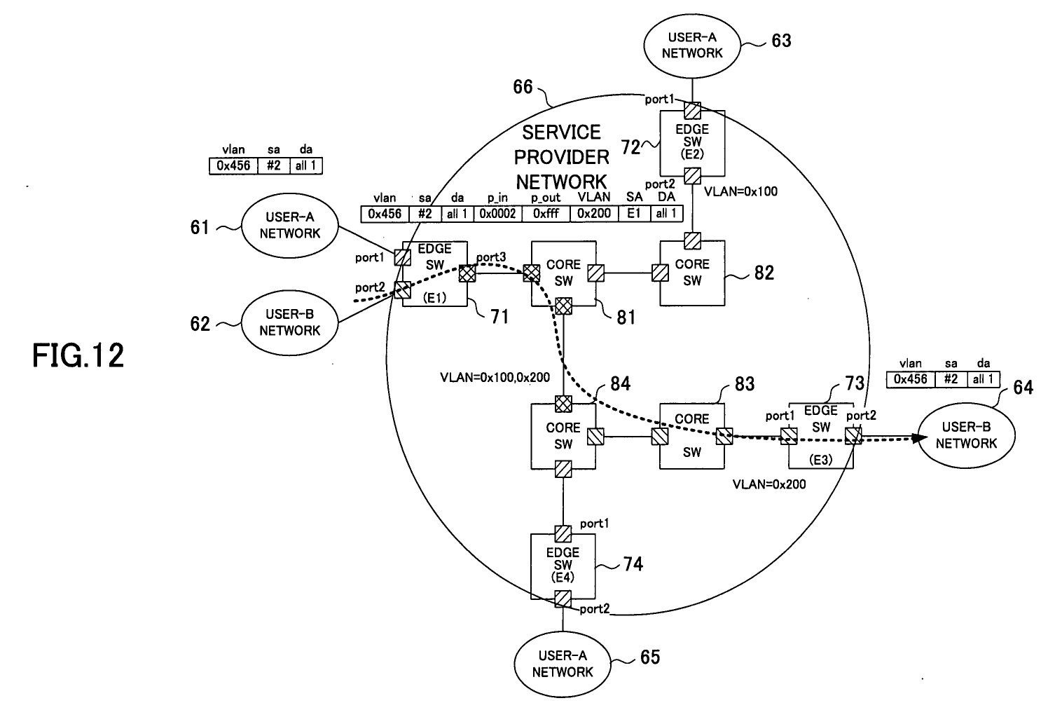

FIG. 12 is a diagram for explaining the transfer process of the multicast frame. In FIG. 12, those parts which are the same as those corresponding parts in FIG. 8 are designated by the same reference numerals, and a description thereof will be omitted. It is assumed that, in a state where the tables within the edge switches 71 through 74 are in the states shown in FIGS. 11A through 11D, the multicast frame is sent from an apparatus having an MAC address #2 within the user-B network 62 with respect to each apparatus within the user-B networks, via the service provider network 66, as shown in FIG. 12. It is assumed that an identifier 0x456 is allocated to the VLAN value (vlan) within the user frame of the user-B network 62.

The edge switch 71 which receives the multicast frame from the user-B network 62 by the port port2 thereof, makes access to the tables within the CAMs 16 and 36 of the edge switch 71 and reads the port identifier 0x0002 and the accommodating VLAN value 0x200 allocated to the port port2.

Since the received frame is the multicast frame, the edge switch 71 sends the multicast frame with respect to all ports (excluding the port that receives the multicast frame) accommodating the VLAN value 0x200 of the ports on the core switch side, without making a retrieval with respect to the tables.

The frame that is sent to the core switch 81 is added with the following data with respect to the user frame.

Destination MAC address DA: ff:ff:ff:ff:ff:ff (all “1”: multicast address)

Sending Source MAC address SA: E1

VLAN value (VLAN) within VLAN tag: 0x200

Port identifier p_in of the switch that receives the frame from the user network: 0x0002

Port identifier p_out connected to the user network of the edge switch that becomes the destination: 0xffff

The transfer process within the service provider network 66 is carried out using the destination MAC address (ff:ff:ff:ff:ff:ff) and the VLAN value (0x200), and the frame is transferred in the order of the core switch 81, the core switch 84, the core switch 83 and the edge switch 73.

When the edge switch 73 receives the frame, the edge switch 73 writes the following entries in the tables within the CAM 52.

Sending source MAC address SA: E1

Port identifier p_in of the switch that receives the frame from the user network: 0x0002

Port identifier of the edge switch 73 that receives the frame from the core switch side: 0x0001

VLAN value (VLAN) within the service provider network 66: 0x200

VLAN value (vlan) within the user frame: 0x456

Sending Source MAC address (sa) within the user frame: #2

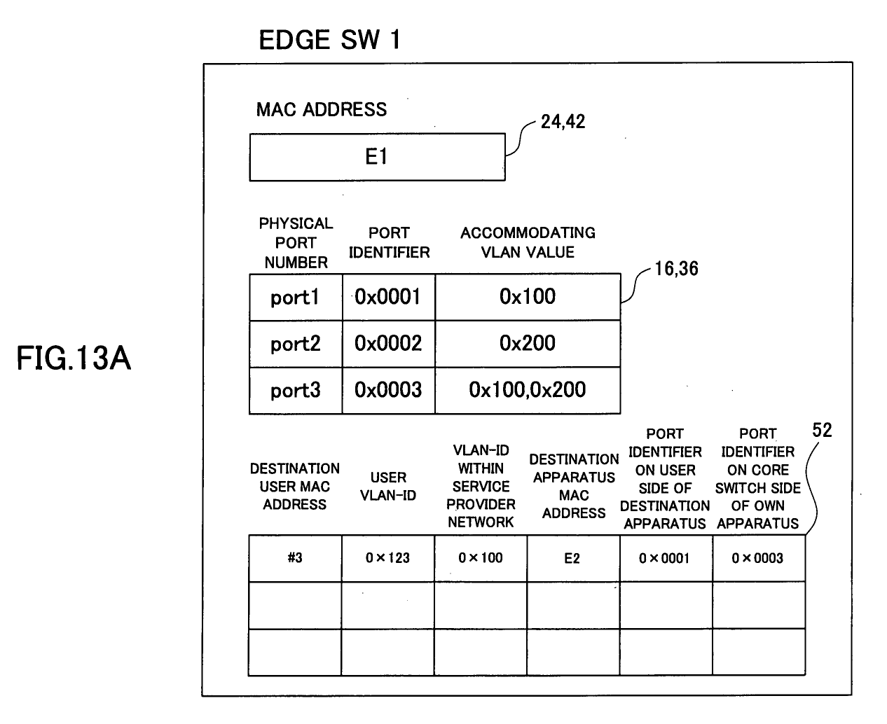

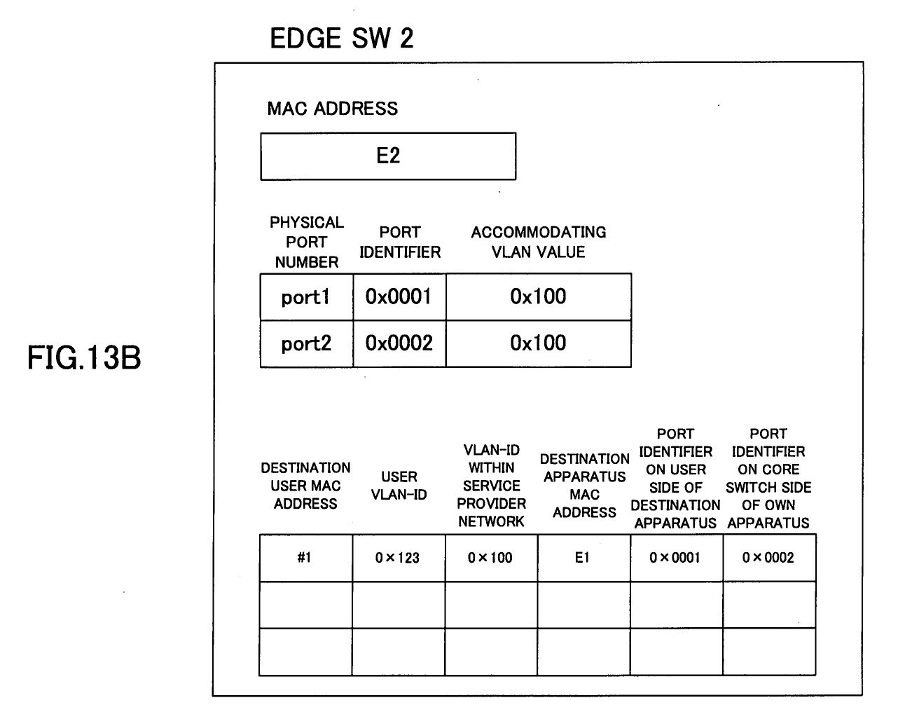

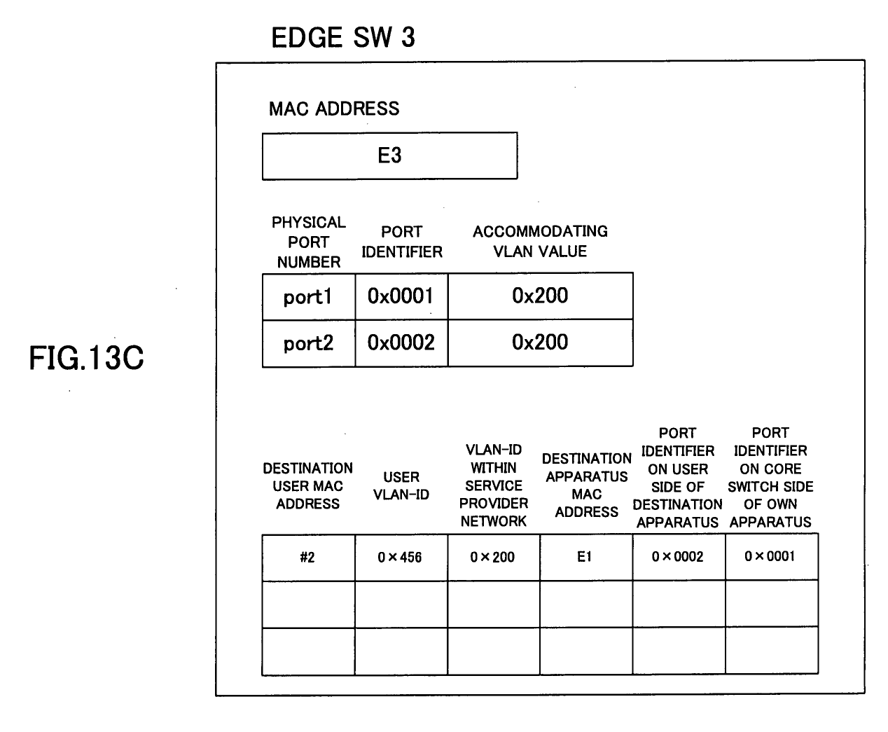

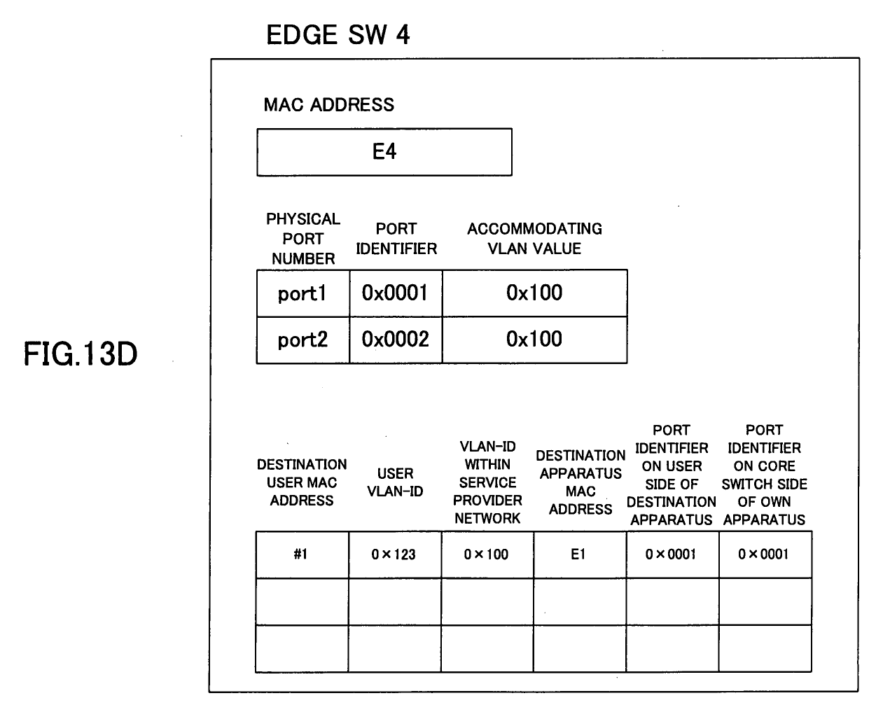

Since the frame received by the edge switch 73 is the multicast frame, the edge switch 73 eliminates the information added in the sending source edge switch from the frame and sends the frame with respect to all ports on the user network side accommodating the VLAN value 0x200 within the service provider network 66. FIGS. 13A through 13D are diagrams showing contents of the tables within each of the edge switches 71 through 74 after relaying the frame. In FIGS. 13A through 13D, the VLAN value is indicated as VLAN-ID.

Next, a description will be given of a transfer process for a case where the frame input from the user-A network is learned in the edge switch 71 but is not learned in the core switch.

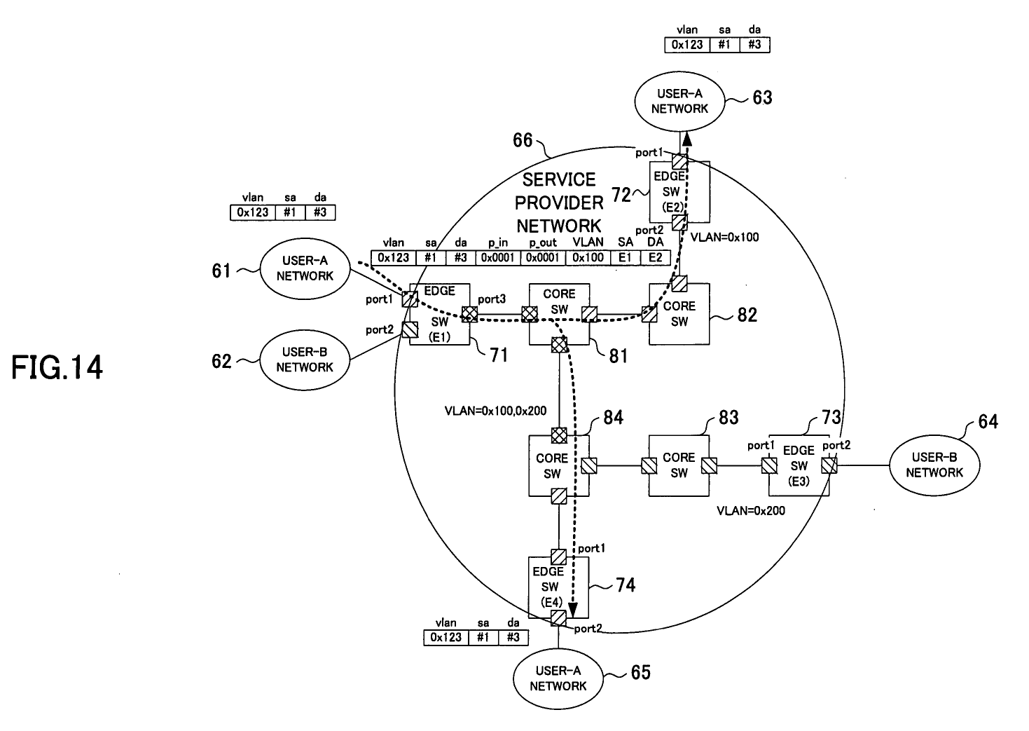

FIG. 14 is a diagram for explaining the transfer process of the unicast frame for the case where learned contents of the core switches are erased. After the learned contents of the core switches 81 through 84 are erased, it is assumed that the frame is sent from the apparatus having the MAC address #1 within the user-A network 61 with respect to the apparatus having the MAC address #3 within the user-A network 63, as shown in FIG. 14.

The edge switch 71 which receives the frame from the user-A network 61 by the port port1 thereof, makes access to the tables within the CAMs 16 and 36 of the edge switch 71, and reads the port identifier 0x0001 and the accommodating VLAN value 0x100 allocated to the port port1.

Next, a retrieval is made from the tables in the CAM 52 using, as the retrieval key, the VLAN-ID=0x123 and the destination MAC address #3 within the user frame and the accommodating VLAN value 0x100 read from the table described above. Since it is found as a result of the retrieval that a registration exists with respect to the retrieval key, the frame is output to the port port3 on the core switch side based on the port identifier 0x0003 of the edge switch 71 stored within the table of the CAM 52.

The frame that is sent to the core switch 81 is added with the following data with respect to the user frame.

Destination MAC address DA: E2

Sending Source MAC address SA: E1

VLAN value (VLAN) within VLAN tag: 0x100

Port identifier p_in of the switch that receives the frame from the user network: 0x0001

Port identifier p_out connected to the user network of the edge switch that becomes the destination: 0x0001

The transfer process within the service provider network 66 is carried out using the destination MAC address (E2) and the VLAN value (0x100), and in the case where the learning table of the core switch 81 is in the unlearned state, the frame is transferred in the order of the core switch 81, the core switch 82 and the edge switch 72, and in the order of the core switch 81, the core switch 84 and the edge switch 74.

When the edge switch 72 receives the frame, the edge switch 72 writes the following entries in the tables within the CAM 52.

Sending source MAC address SA: E1

Port identifier p_in of the switch that receives the frame from the user network: 0x0001

Port identifier of the edge switch 72 that receives the frame from the core switch side: 0x0002

VLAN value (VLAN) within the service provider network 66: 0x100

VLAN value (vlan) within the user frame: 0x123

Sending Source MAC address (sa) within the user frame: #1

Since the destination MAC address is E2, the edge switch 74 judges that the received frame is not intended for the edge switch 74, and discards the received frame.

Since the frame received by the edge switch 72 is the unicast frame intended for the edge switch 72, the edge switch 72 eliminates the information added in the sending source edge switch from the frame and sends the frame with respect to the port port1 by judging this port port1 from the destination port identifier 0x0001.

Therefore, by using the edge switch of the present invention in the broadband network, it becomes possible to use a generally used switch which processes the VLAN frame as the core switch. In addition, since the MAC address which is the target of the learning in the core switch becomes the MAC address allocated to the edge switch, it becomes possible to suppress the number of learning processes to be carried out compared to the conventional techniques. As a result, it is possible to avoid the learning table for the MAC address from becoming exhausted, and to simultaneously improve the performance, that is, the transfer delay, of the core switch. Moreover, because the judging of the transfer destination within the edge switch and the frame encapsulation can be carried out in parallel, it becomes possible to improve the performance of the edge switch.

The CAMs 16 and 22 and the processors 12 and 20 form a header information adding part or means. The CAM 22 and the processor 20 form second and third identifier retrieving parts or means. The CAM 48 and the processor 44 form a learning part or means. The CAM 36 and the processor 50 form a user network output port retrieving part or means.

Further, the present invention is not limited to these embodiments, but various variations and modifications may be made without departing from the scope of the present invention.

What is claimed is:

1. A frame transfer method for transferring frames in a service provider network that couples to a user network in a broadband network in which a plurality of user networks are coupled via the service provider network, comprising:
receiving a user frame that is input from a user network by a first edge switch within the service provider network that is coupled to the user network; and
adding header information to the user frame in the first edge switch and outputting the frame that is added with the header information from the first edge switch to a core switch within the service provider network,
wherein said header information includes a first address that is unique within the service provider network and is allocated to the first edge switch, a second address that is unique within the service provider network and is allocated to a second edge switch coupled to a user network that becomes a destination, a virtual local area network (VLAN) value allocated to a network within the service provider network, a first port identifier identifying a port of the first edge switch that receives the user frame, and a second port identifier identifying a port of the second edge switch.

2. The frame transfer method as claimed in claim 1, further comprising:
retrieving the VLAN value and the first port identifier from a memory part within the first edge switch, using an input port number of the port of the first edge switch that receives the user frame as a retrieval key.

3. The frame transfer method as claimed in claim 2, further comprising:
retrieving the second address and the second port identifier from the memory part within the first edge switch, using a destination address within the user frame, a VLAN value within a VLAN tag allocated within the user network from which the user frame is input, and the VLAN value allocated to the network within the service provider network and allocated to each input port of the first edge switch, as a retrieval key; and
retrieving a third port identifier identifying a port of the first edge switch that outputs the frame to the service provider network, using the destination address within the user frame, the VLAN value within the VLAN tag allocated within the user network from which the user frame is input, and the VLAN value allocated to the network within the service provider network and allocated to each input port of the first edge switch, as a retrieval key.

4. The frame transfer method as claimed in claim 1, further comprising:
retrieving the second address, the second port identifier, and a third port identifier identifying a port of the first edge switch that outputs the frame to the service provider network, using a destination address within the user frame, a VLAN value within a VLAN tag allocated within the user network from which the user frame is input, and a VLAN value allocated to the network within the service provider network and allocated to each input port of the first edge switch, as a retrieval key.

5. An edge switch for transferring frames in a service provider network that couples to a user network in a broadband network in which a plurality of user networks are coupled via the service provider network, comprising:
a port configured to receive a user frame that is input from a user network, within the service provider network that is coupled to the user network; and
a header information adding part configured to add header information to the user frame and outputting the frame that is added with the header information to a core switch within the service provider network,
wherein said header information includes a first address that is unique within the service provider network and is allocated to the edge switch, a second address that is unique within the service provider network and is allocated to another edge switch coupled to a user network that becomes a destination, a virtual local area network (VLAN) value allocated to a network within the service provider network, a first port identifier identifying the port that receives the user frame, and a second port identifier identifying a port of the other edge switch.

6. The edge switch as claimed in claim 5, further comprising:
a memory part; and
a first identifier retrieving part configured to retrieve from the memory part the VLAN value and the first port identifier, using an input port number of the port that receives the user frame as a retrieval key.

7. The edge switch as claimed in claim 6, further comprising:
a second identifier retrieving part configured to retrieve from the memory part the second address and the second port identifier, using a destination address within the user frame, a VLAN value within a VLAN tag allocated within the user network from which the user frame is received, and the VLAN value allocated to the network within the service provider network and allocated to each input port of the edge switch, as a retrieval key; and
a third identifier retrieving part configured to retrieve from the memory part a third port identifier identifying a port of the edge switch that outputs the frame to the service provider network, using the destination address within the user frame, the VLAN value within the VLAN tag allocated within the user network from which the user frame is received, and the VLAN value allocated to the network within the service provider network and allocated to each input port of the edge switch, as a retrieval key.

8. The edge switch as claimed in claim 5, further comprising:
a memory part; and
second and third identifier retrieving parts configured to retrieve from the memory part the second address, the second port identifier, and a third port identifier identifying a port of the edge switch that outputs the frame to the service provider network, using a destination address within the user frame, a VLAN value within a VLAN tag allocated within the user network from which the user frame is received, and a VLAN value allocated to the network within the service provider network and allocated to each input port of the edge switch, as a retrieval key.

9. The edge switch as claimed in claim 8, further comprising:
a part configured to set the second address as a multicast address, specify multicasting to each output port of the edge switch, and specify multicasting to each output port of the other edge switch, if the user frame is a multicast frame or the retrieval cannot be made by the second and third identifier retrieving parts.

10. The edge switch as claimed in claim 8, further comprising:
a service provider network output port retrieving part configured to retrieve from the memory part a port of the edge switch that outputs the frame to the service provider network, using the third port identifier as a retrieval key.

11. The edge switch as claimed in claim 10, wherein said service provider network output port retrieving part retrieves all ports of the edge switch accommodating a VLAN value allocated to the network within the service provider network if the second address is a multicast address.

12. An edge switch for transferring frames in a service provider network that couples to a user network in a broadband network in which a plurality of user networks are coupled via the service provider network, comprising:
a first port configured to receive a frame that is added with header information and is input from the service provider network;
a second port configured to receive a frame that is input from a user network that is coupled to the service provider network; and
a learning part configured to learn the header information,
wherein said header information includes an address that is unique within the service provider network and is allocated to another edge switch within the service provider network that is coupled to the user network, a virtual local area network (VLAN) value allocated to a network within the service provider network, a first port identifier identifying the second port that receives the frame, a sending source address within a user frame in the frame that is input from the service provider network, a VLAN value within a VLAN tag that is allocated within the user network, and a second port identifier identifying the first port of the edge switch that receives the frame from the service provider network.

13. The edge switch as claimed in claim 12, wherein the learning part includes a memory part, and further comprising:
a receiving part configured to retrieve from the memory part the VLAN value allocated to the network within the service provider network and the second port identifier, using an input port number of the first port as a retrieval key.

14. The edge switch as claimed in claim 13, further comprising:
a setting part configured to input learning contents of the learning part via an external interface.

15. The edge switch as claimed in claim 13, further comprising:
a third port coupled to the user network; and
an output port retrieving part configured to retrieve from the memory part the third port that outputs the user frame to the user network, using a third port identifier as a retrieval key, said third port identifier identifying a port of the other edge switch coupled to the user network and added in the header information of the frame that is input from the service provider network.

16. The edge switch as claimed in claim 15, wherein the output port retrieving part retrieves all ports of the edge switch accommodating the VLAN value allocated to the network within the service provider network, if the third port identifier indicates multicasting.

17. An edge switch for transferring frames in a service provider network that couples to a user network in a broadband network in which a plurality of user networks are coupled via the service provider network, comprising:
at least one port configured to receive a user frame that is input from a user network, within the service provider network that is coupled to the user network;
at least one port configured to receive a frame that is added with header information and is input from the service provider network;
a header information adding part configured to add header information to the user frame and outputting the frame that is added with the header information to a core switch within the service provider network; and
a learning part configured to learn the header information,
wherein said header information includes a first address that is unique within the service provider network and is allocated to the edge switch, a second address that is unique within the service provider network and is allocated to another edge switch coupled to a user network that becomes a destination, a virtual local area network (VLAN) value within a VLAN tag that is allocated to a network within the service provider network, a first port identifier identifying the port that receives the user frame from the user network, a second port identifier identifying a port of the other edge switch, a third port identifier identifying the port that receives the frame from the service provider network, and a sending source address within a user frame in the frame that is input from the service provider network.
